(19) United States
(12) Patent Application Publication
(10) Pub. No.: US 2005/0216742 A1
(43) Pub. Date: Sep. 29, 2005

(54) Document signature method & system

(76) Inventors: Yaw Ming Wong, Singapore (SG); Khai Yin Fong, Singapore (SG)

Correspondence Address: HOWREY LLP, C/O IP DOCKETING DEPARTMENT, 2941 FAIRVIEW PARK DR, SUITE 200, FALLS CHURCH, VA, 22042-2924, US

(21) Appl. No.: 11/089,282

(22) Filed: Mar. 23, 2005

(30) Foreign Application Priority Data
Mar. 24, 2004 (SG) 200401582-2

(51) Int. Cl. H04L 9/00

(52) U.S. Cl. 713/176

(57) ABSTRACT

A system and method for executing a document in a verifiable manner is described where the system displays an electronic document, receiving an identifying characteristic of a party executing the document. The system then adds an electronic form of the identifying characteristic to the electronic document and receives confirmation that the electronic form of identifying characteristic is authentic. On receipt of confirmation the system digitally signs and stores the electronic document.

### TECHNICAL FIELD

The present invention relates to a method and system for executing a document in a verifiable manner.

### BACKGROUND PRIOR ART

A digital signature is a critical component of electronic commerce as ti provides the condition of non-repudiation when an electronic contract is “executed”. Digital signatures as we know them have a shortcoming that curtails their usefullness.

A digital signature is to electronic document as a handwritten signature is to printed dicuments. Digital signatures are generally considered to be unforgeable. The presence of a digital signature asserts that a named person either wrote or otherwise agreed to the contents of the document to which the digital signature is attached.

Digital signatures provide a greater degree of security than a handwritten signature. The digital signature on an electronic document assures the recipient that the signer of the document is who they assert they are and that the content of the document has not been altered either intentionally or accidentally since it was signed. Furthermore, secure digital signatures cannot be repudiated; the signer of a dicument cannot later disown it by claiming the signature was forged.

Digital signature enable “authentication” of digital documents, assuring the recipient of a digital document of both the identity of the sender and the integrity of the content.

The current use of digital signatures can be illustrated with an example. Suppose Alice wants to send a signed message to Bob. She creates a message digest by using a hash function on the message. The message digest serves as a “digital fingerprint” of the message; if any part of the message is modified, the hash function returned by the altered document is different. Alice then encrypts the message digest with her private key. The encrypted message digest is the digital signature of the message.

To sent the signed document Alice sends both the message and the digital signature to Bob. When Bob receives them, he decrypts the signature using Alice's public key, to reveal the message digest. To verify the message, he then hashes the message with the same hash function Alice used and compares the result to the message digest received from Alice. To ensure the same hash function is used the signature usually includes an indicator of the hash function used. If the hashes are exactly equal, Bob can be confident that the message was signed by Alice and has not been altered since she signed it. If the hashes are not equal, Bob can conclude that the message did not originate from where he thought or that the contents had been altered either deliberately or accidentally after it was signed.

There is no requirement when using a digital signature to encrypt the message itself. If Alice wants to ensure the privacy of her message to Bob, she must also encrypt the message using Bob's public key. In this case only Bob can reed the message by decrypting it with his private key.

With the hash functions typically usedit is not feasible for anyone to either find a message that hashes to a given value or to find two messages that hash to the same value. If either were feasible, an intruder could attach a false message onto Alice's signature.

Digital signatures are therefore useful for e-commerce, they made it difficult to repudiate a contract signed with a digital signature.

In spite of the obvious benefits of digital signatures, they are not widely used. The main reason for the limited use is that using digital signatures is not easy. Further there are costs associated with digital signatures for both businesses and consumers.

### DISCLOSURE OF THE INVETION

It is an object of the present invention to provide method and system for executing a document which goes someway to overcoming the above mentioned disadvantages or which will at least provide the public with a useful choice.

Accordingly in a first aspect the invention may be said to consist in a system for executing a document in a verifiable manner comprising:
a processor with memory and process execution unit;
a display device responsive to said processor;
at least one input device, said at least one input device including means for capturing an identifying characteristic of at least one party device executing said document, said at least one input device connected to said processor;
storage means accessible by said processor;
wherein said processor is programmed to:
   display a file representative of said document on said display device,
   request the input of at least one identifying characteristic,
   capture and store in memory each said at least one identifying characteristic inputted,
   add each said at least one identifying characteristic to said file,
   request input confirms the input of said at least one identifying characteristic by said at least one party executing said document,
   digitally sign said file on receipt of said confirming input, and
   store said signed document in said storage means.

Preferably said input device is a pen tablet and sign identifying characteristic is a physical signature mark.

Preferably said input device is a biomentrics reader.

Preferably said identifying characteristic is a finger print.

Preferably said identifying characteristic is a retina scan.

Accordingly in a second aspect the invention may be said to consist in method of executing a document in a verifiable manner comprising the steps of:
displaying an electronic document;
receiving an identifying characteristic of a party executing said document;
adding an electronic form of said identofying characteristic to said electronic document;
receiving confirmation that said electronic form of said identifying characteristic is authentic;
digitally signing said electronic document; and
storing said electronic document.

Preferably said identifying characteristic is a physical signature or mark.

Preferably said identifying characteristic is a finger print.

Preferably said identifying characteristic is a retina scan.

### BRIEF DESCRIPTION OF THE DRAWINGS

One preferred form of the present invention will now be described with reference to the accompanying drawings in which

FIG. 1 is a diagram of the hardware of the present invention,

FIG. 2 is a flow diagram of process of the present invention,

FIG. 3 is a screenshot showing an example document,

FIG. 4 is a screenshot showing an example signing interface of the present invention,

FIG. 5 is a screenshot showing an example signing interface of the present invention prompting for a signature,

FIG. 6 is a screenshot showing an example interface of the present invention with all the required signatures provided,

FIG. 7 is a screenshot showing an example interface of the present invention with all the entered signatures merged with the document,

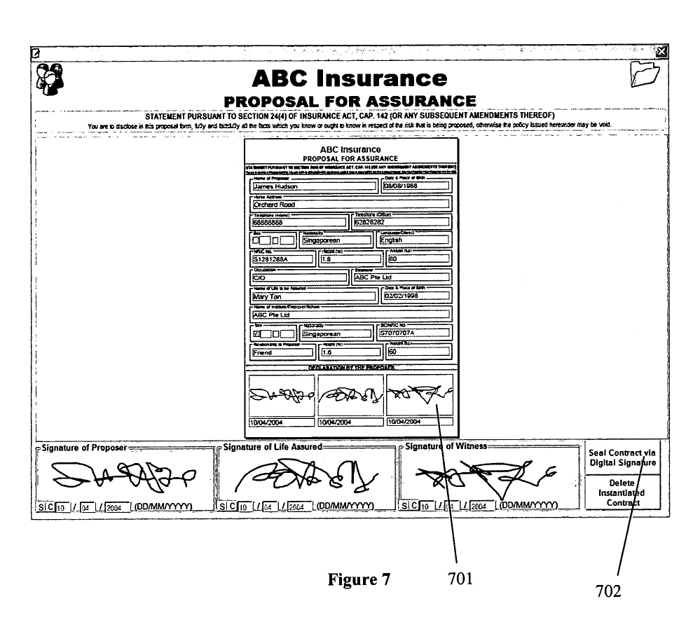

FIG. 8 is a screenshot showing an example interface of the present invention prompting for a password to access a digital signature, and

FIG. 9 is a screenshot showing an example interface of the present invention showing a successful sealing.

### BEST MODE FOR CARRYING OUT THE INVENTION

A contract between two or more parties can be sealed when the signing parties come together in a face-to-face meeting to sign or execute the contract. This signed paper copy of the contract becomes the authenticated record of the agreement between the parties.

The present invention seeks to replicate electronically the ease by which this conventional method of pen-signing the paper copy occurs. The present invention allows all the accompanying advantages of record and management of electronic documents to enjoyed by the users of the contract.

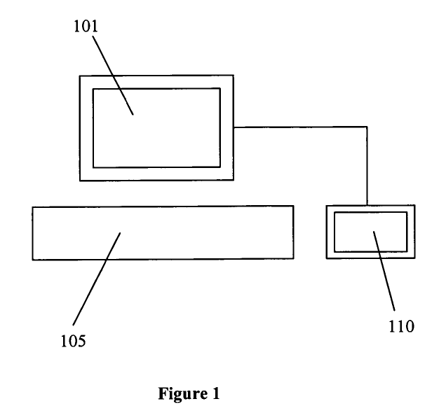

Referring to FIG. 1 the system of the present invention includes a computer 101 programmed to implement the present invention. The computer includes a processor, memory, storage which may include a hard drive or solid state storage. The computer may also include various input devices 105 and in particular must include an input device allowing the capture of an identifying characteristic of a party executing the document. Such devices would include biometric readers and pen tablets.

Using current technology, it easy to convert a paer copy of a document into digital form. However, to mimic the pen-signing process electronically is more cumbersome. The signing parties are requierd to each possess a digital signature and hardware that enables them to sign the digital copy of the contract electronically. Most signing parties are unwilling to be saddled with the cost of obtaining signatures and the necessary hardware. As such, the use of electronic signatures and electronic documents to execute a contract is not widespread.

This present invention makes it feasible and convenient for the signing parties to a contract to be able to execute the document electronically.

To sign a document an electronic version of the document is created. This may either be by creating the document using a word processor or by scanning a paer copy and saving the scanned copy in electronic form.

The parties who are to execute the document check that the contents of the electronic version are as they expect the document to be. The executing parties then execute on a pen tablet using their usual signature. The system of the present invention converts the written signature as it is written on the tablet into an electronic form. the electronic form of the signature is then superimposed onto the electronic document by the present invention.

The visual appearance of the signature in the electronic document indicates the intention and will of the signing parties. The party who is witnessing the signing counter-signs the document using their digital signature. The dicument state at the time the digital signature of the witness is applied is known and any subsequent changes to the document would result in an invalid hash.

Only the officiating party is required to have a digital key and be equipped with the necessary software and hardware to digitally sign the document. The officiating party obtains their digital keys as is know in te art. This present invention combines the simplicity of manually signing a document with the security of digital signatures. The digital content is protected and non-repudiation is secured.

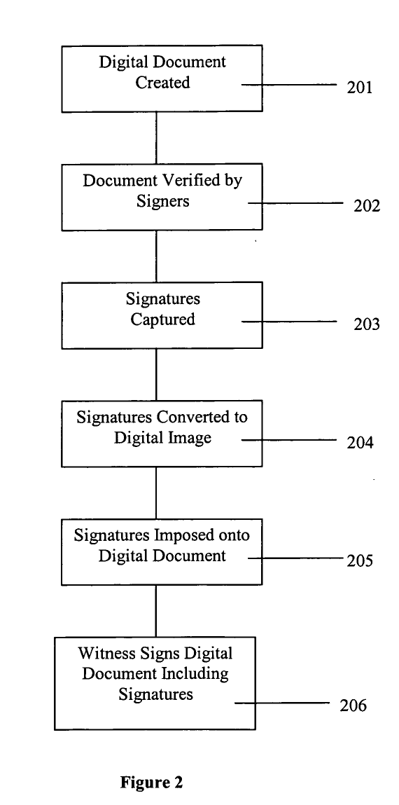

The process of the present invention will now be described with reference to FIG. 2. The electronic contract is first created 201 and stored. The parties who are going to sign or execute the document are presented with it 202. It is critical that the signatories see the entire electronic contract clearly. If the contract is multi-paged, all pages should exist in one file. When the signatories' have agreed to the document they sign on a pen tablet using their usual signature. The pen strokes are captured 203 by the pen tablet converted into a digital form 204 and added 205 to the contract. In an alternative embodiment the signatures would be added to a particular part of the document such as a signature panel.

Depending on the nature of the contract the signature can also be added to every page of the electronic form if it is multi-paged. the next step is to digitally sign the document. The first step of this process is to calculate a hash-value of the elctronic form (often called the message digest) by applying some ctyptographic hashing algorythm (for example, MD2, MD4, MD5, SHA1, or others). The calculated hash-value of the electronic form is a sequence of bits, usually with a fixed length, extracted in some manner from the form. All reliable algorithms for message digest calculation apply mathematical transformations that when even a single bit of the input is changed, a completely different digest is obtained.

In the second step of digitally signing the elctronic form, the information obtained in the first step hash-value of the electronic form (the message digest) is encrypted with the private key of the person who signs the elctronic form and thus an encrypted hash-value, also called a digital signature, is created. For this purpose, an encrypting algorithm for calculating digital signatures from the message digest is used. The most often used algorithms are RSA (based on the number theory), DSA (based on the theory of te discrete logarithms), and ECDSA (based on the elliptic curves theory). The computed digital signature is then attached together with the document in a special format to be verified if necessary.

While the system can be used with pen tablets to a capture a physical signature or some other physical indicator of agreement the system can equally be used with biometric readers to capture for example a finger or thumb print or a retina scan.

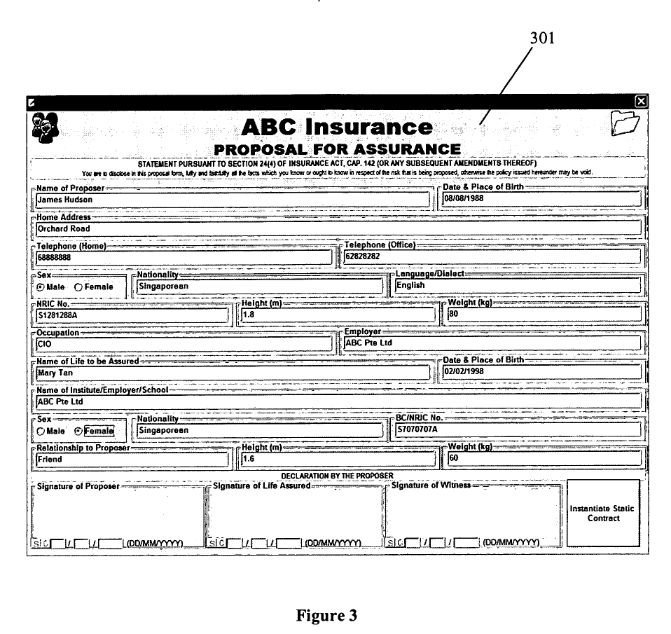

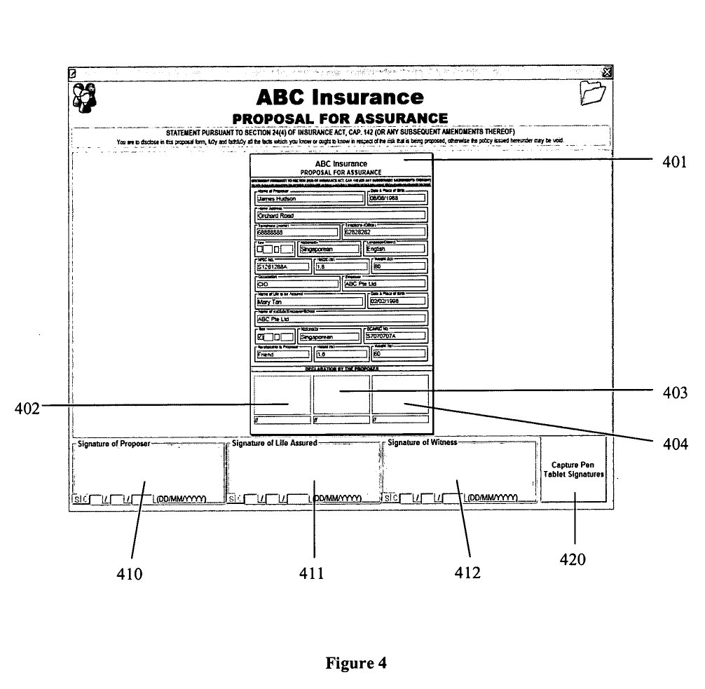

The present invention will now further be described with reference to an example application. The example is an insurance proposal system installed on a laptop of those selling insurance. The information required is created in a form 301 can be completed; an example of such a form shown in FIG. 3. The information is entered in the form and the system saves the form. The system then presents the form for signing; referring to FIG. 4 the parties to the contract have an opportunity to read the information on the form 401, in the preferred embodiment the form includes signature panels 402, 403, 404. The system includes panels for displaying the inputted signatures 410, 411, 412. The user using a mouse or other means selects a button “Capture Pen tablet Signature” 420.

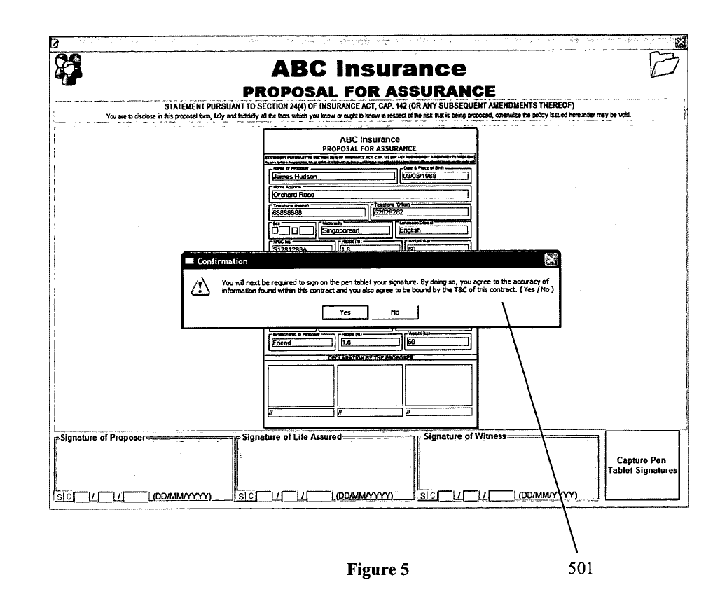

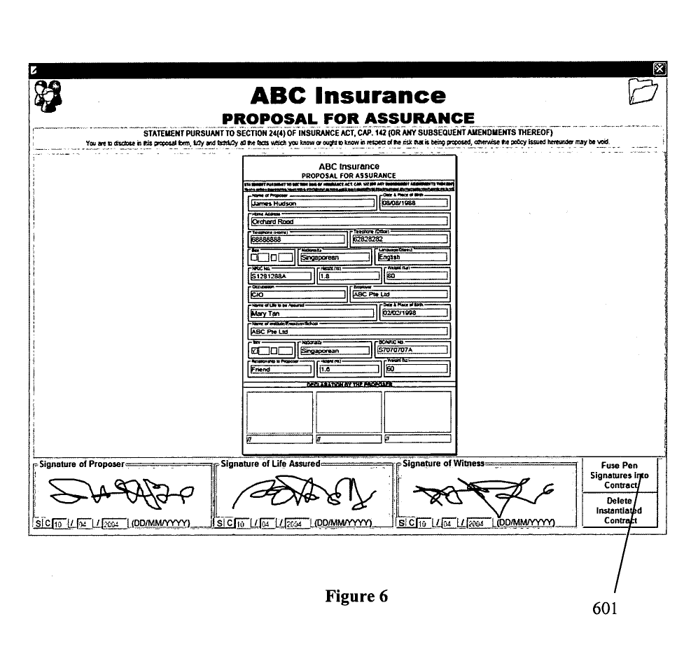

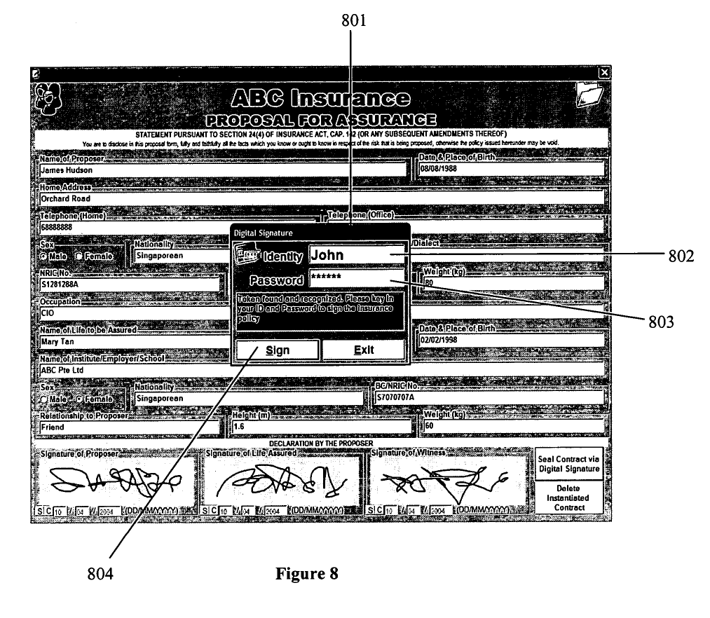

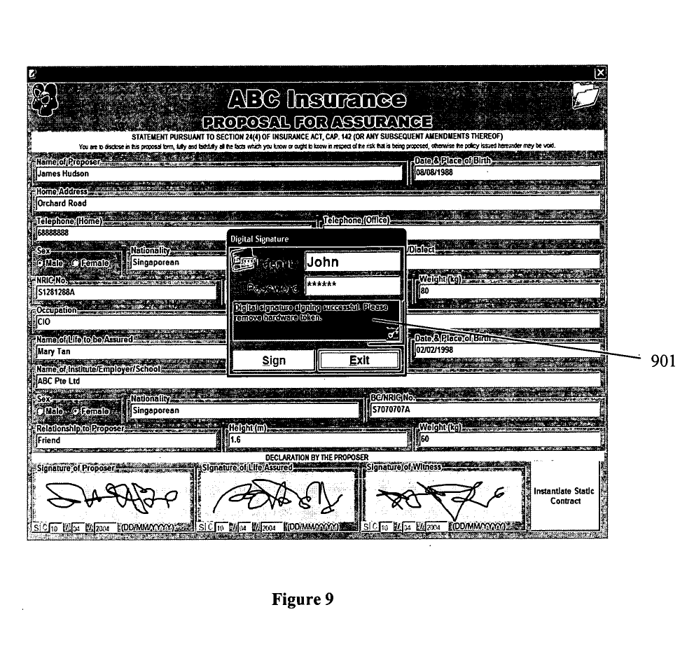

Referring to FIG. 5 the system then prompts the signer to confirm 501 that they agree to the document displayed. Each signer then in turn sugns using a pen tablet, in an alternative embodiment a user could indicate their approval using a finger or thumb print or using a seal. The user is also required to enter the date that they signed 502. Referring to FIG. 6 once all the signatures are captured and the dates entered the system then displays a button 601 allowing a user to click to merge the signatures into the document file. the document is then displayed with the signatures inserted 701. A button 702 to allow the file to be sealed using a digital signature is displayed. Referring to FIG. 8 when this is clicked on the system displays a dialog box 801 asking for the signature identity 802 and the password for that identity 803 to be entered. Once the user has entered the information the users clicks a button 804 to electronically sign and seal the document. If successful the system displays a dialog box 901 shown in FIG. 9 confirming that the file has been signed, sealed and saved. In the preferred embodiment the signed file would be uploaded to a secure storage area of a server and deleted from the laptop or other computer used for the signing.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1. A system for executing a document in a verifiable manner comprising:
a processor with memory and a process execution unit;
a display device responsive to said processor;
at least one input device, said at least one input device including means for capturing an identifying characteristic of at least one party device executing said document, said at least one input device connected to said processor;
storage means accessible by said processor;
wherein said processor is programmed to:
display a file representative of said document on said display device,
request the input of at least one identifying characteristic,
capture and store in memory each said at least one identifying characteristic inputted,
add each said at least one identifying characteristic to said file,
request input confirms the input of said at least one identifying characteristic by said at least one party executing said document,
digitally sign said file on receipt of said confirming input, and
store said signed document in said storage means.

2. A system for executing a document in a verifiable manner as claimed in claim 1 wherein said input device is a pen tablet and said identifying charcteristic is a physical signature or mark.

3. A system for executing a document in a verifiable manner as claimed in claim 1 wherein said input device is a biometrics reader.

4. A system for executing a document in a verifiable manner as claimed in claim 3 wherein said identifying charcteristic is a finger print.

5. A system for executing a document in a verifiable manner as claimed in claim 3 wherein said identifying characteristic is a retina scan.

6. A method for executing a document in a verifiable manner comprising the steps of:
displaying an electronic document;
receiving an identifying characteristic of a party executing said document;
adding an electronic form of said identofying characteristic to said electronic document;
receiving confirmation that said electronic form of said identifying characteristic is authentic;
digitally signing said electronic document; and
storing said electronic document.

7. A method for executing a document in a verifiable manner as claimed in claim 6 wherein said identifying characteristic is a physical signature or mark.

8. A method for executing a document in a verifiable manner as claimed in claim 6 wherein said identifying characteristic is a finger print.

9. A method for executing a document in a verifiable manner as claimed in claim 6 wherein said identifying characteristic is a retina scan.
